(19) United States
(12) Patent Application Publication
(10) Pub. No.: US 2009/0077185 A1
(43) Pub. Date: Mar. 19, 2009

(54) Automatic-reply instant messeging system and method thereof

(75) Inventors: Chaucer Chiu, Taipei (TW); Ya-Li Wang, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/898,824

(22) Filed: Sep. 17, 2007

(51) Int. Cl. G06F 15/82

(52) U.S. Cl. 709/206

(57) ABSTRACT

An automatic-reply instant messaging system and a method thereof are provided. First, an identity classification of a contactor is previously classified, when the contactor sends a message to a computer platform, a recognition unit and a message meaning identification unit in the computer platform respectively recognizes the identity classification of the contactor and identifies the meaning of the message, and appropriate texts are selected from a text database to constitute a reply message to reply to the contactor. Therefore, when in some occasion a user on the computer platform is unwilling to or incapable of replying to the message in person, the automatic-reply instant messaging system and the method thereof are used to reply with an appropriate message, so as to avoid misunderstanding between the user and the contactor due to busyness or bad mood on such occasion.

### BACKGROUND OF THE INVENTION

1. Field of Invention

The present invention relates to an instant messaging system and a method thereof. More particularly, the present invention relates to an instant messaging system and a method thereof which are capable of replying to a message according to an identity classification of a contactor and a meaning of the message.

2. Related Art

Recently, commonly used instant messaging systems such as MSN, QQ, or Yahoo Messenger, have become important tools for exchanging information of many users and even for cooperating to accomplish task with remote colleagues.

However, in these instant messaging systems, unless the user block a certain contactor or is shown as “offline”, some contactors will still attempt to send messages and contact with the user even if the user is shown as “busy” or other status. However, if the user is unwilling to reply to the message or is in a bad mood, it is probable that the user replies to the message with an unfriendly manner, which will cause a misunderstanding with the contactor. If the contactor is one of the user's good friends, the contactor may break off the relationship with the user after this unhappy experience; and if the contactor is one of the user's partners in business or public affairs, the user may lose the chance for the further cooperation due to such an event.

Therefore, it is discussed eagerly by the present invention how to develop an instant messaging system and a method thereof for replying to a message according to an identity classification of the contactor and the meaning of the message, which can act as the user's agent to reply with an appropriate message when the user is unwilling to or incapable of replying to the message.

### SUMMARY OF THE INVENTION

In view of the defect that the conventional instant messaging system and a method thereof cannot act as the user's agent to reply with an appropriate message when the user is unwilling to or incapable of replying to the message, the present invention provides an automatic-reply instant messaging system and a method thereof, which are capable of replying to a message according to an identity classification of a contactor and a meaning of the message.

The automatic-reply instant messaging system of the present invention at least includes: a receiving unit, for receiving the message of at least one contactor; a recognition unit, for recognizing an identity classification of the contactor; a message meaning identification unit, for identifying a meaning of the message; a text database; a message constituting unit, for selecting texts from the text database according to the identity classification and the meaning of the message and constituting the texts into a reply message; and a message sending unit, for sending the reply message to the contactor.

The automatic-reply instant messaging method of the present invention applicable to a computer executable platform at least includes the following steps. First, the computer executable platform receives a message of at least one contactor; a recognition unit recognize the identity classification of the contactor; when the identity classification of the contactor is recognize, a message meaning identification unit identifies the meaning of the message; the computer executable platform selects texts from a text database according to the identity classification and the meaning, and a message constituting unit constitutes the texts into a reply message; and finally a message sending unit sends the reply message to the contactor.

Therefore, when the user is unwilling to or incapable of replying to the message, the automatic-reply instant messaging system and a method thereof according to the present invention can reply to the message according to the identity classification of the contactor and the meaning of the message, so as to avoid misunderstanding between the user and the contactor due to the unfriendly manner of reply messages when the user is unwilling to reply to the message or is in a bad mood.

The features and examples of the embodiments of the present invention are illustrated in detail with reference to the drawings below.

### BRIEF DESCRIPTION OF THE DRAWINGS

The present invention will become more fully understood from the detailed description given herein below for illustration only, and thus are not limitative of the present invention, and wherein:

FIG. 1 is a block diagram of an automatic-reply instant messaging system according to the present invention.

FIG. 2 is a flow chart of the automatic-reply instant messaging system according to the present invention.

FIGS. 3A to 3D are schematic view of specific embodiments of the present invention.

### DETAILED DESCRIPTION OF THE INVENTION

The present invention provides an automatic-reply instant messaging system which is applicable to a computer executable platform such as a desktop computer, a laptop computer, or a handheld computer apparatus, which is not limited herein.

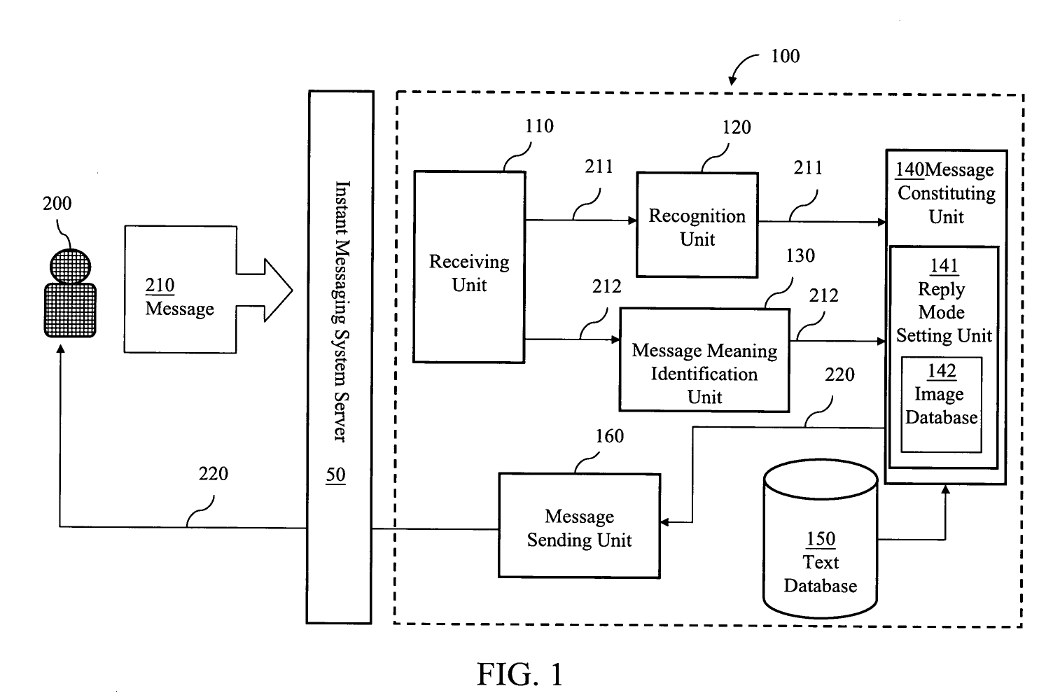

FIG. 1 is a block diagram of an automatic-reply instant messaging system according to the present invention. Referring to FIG. 1, the instant messaging system 100 is applicable to the computer executable platform that mentioned above, and includes: a receiving unit 110, for receiving a message 210 of at least one contactor 200 through an instant messaging system server 50, where the message 210 includes an identity classification message 211 of the contactor 200 and a text message 212; a recognition unit 120, for identifying an identity classification of the contactor 200 through the identity classification message 211; a message meaning identification unit 130, for identifying a meaning of the text message 212; a message constituting unit 140, having a reply mode setting unit 141, for selecting texts from a text database 150 according to the identity classification message 211 and the meaning of the text message 212 and constituting the texts into a reply message 220 through a preset reply mode; and a message sending unit 160, for sending the reply message 220 to the contactor 200 through the instant messaging system server 50.

The above identity classification message 211 is used for displaying the identity classification of the contactor 200, and can be classified according to the classification information such as interest and occupation of the contactor 200, and can be further classified into other detailed classifications under the classification information. The more detailed classification can improve the accuracy of the constituted reply message 220. For example: the interest can be further classified into the detailed classifications such as athletics, reading, shopping, and fashion; the occupation can be further classified into the detailed classifications such as lawyer, engineer, and service personnel. Moreover, the reply mode can be set by the user previously in the reply mode setting unit 141 according to the automatic reply or manual reply status, or the different status such as busy, offline, calling, or out. Therefore, when the user is unwilling to reply to the message or is in a bad mood, the automatic-reply instant messaging system of the present invention can be used to reply to the message according to the identity classification of the contactor and the meaning of the message, so as to avoid misunderstanding between the user and the contactor due to the unfriendly manner of the reply message.

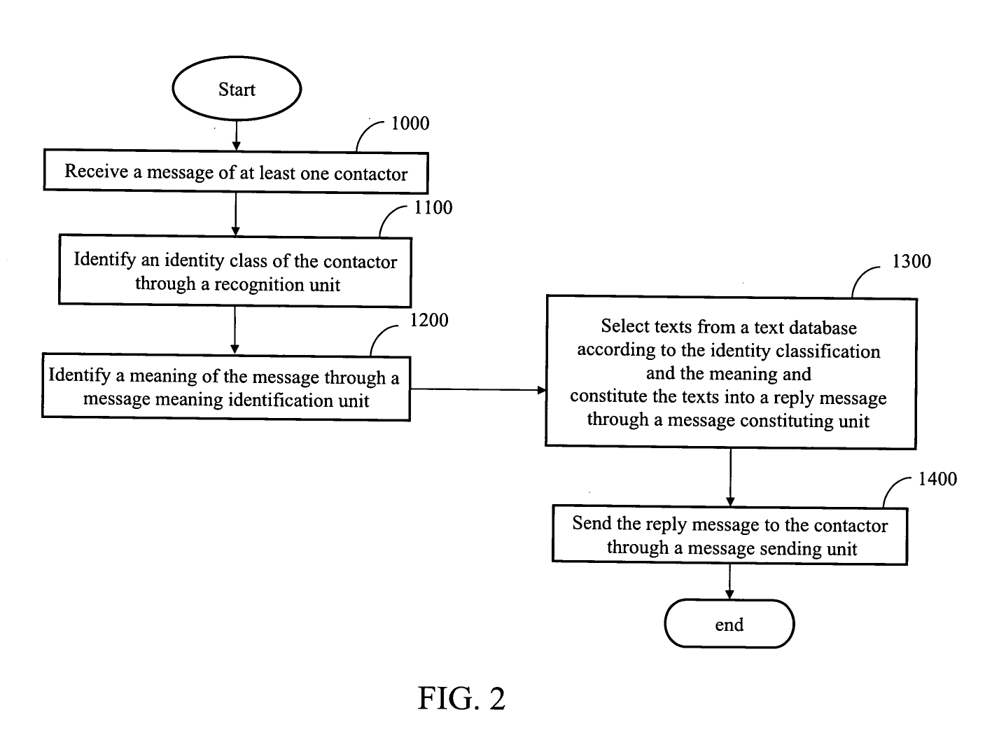

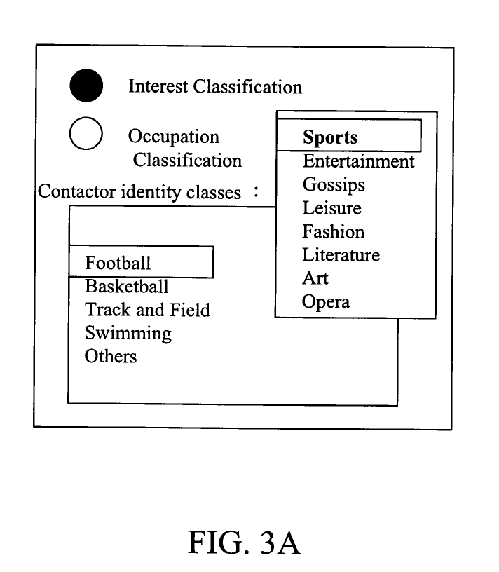

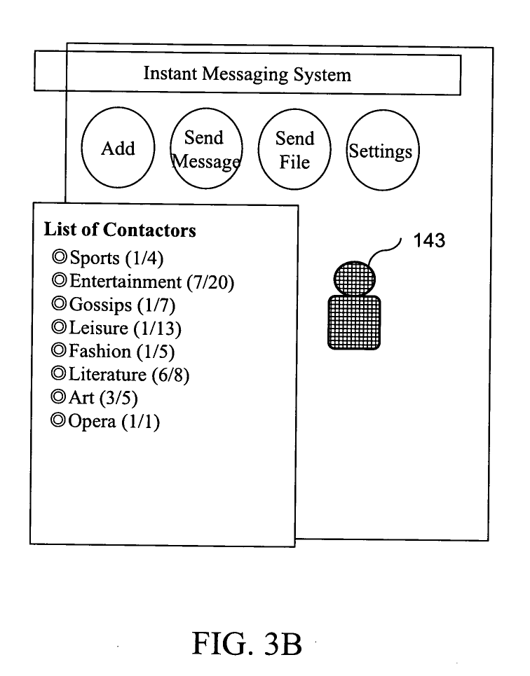

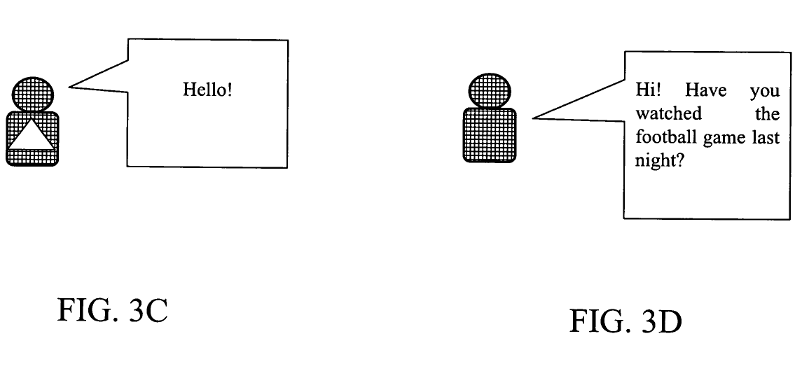

FIG. 2 and FIG. 3A-3D are a flow chart and the schematic view of specific embodiment of the automatic-reply instant messaging method according to the present invention. Referring to FIG. 2 and FIGS. 3A-3D together with FIG. 1, when the user intends to use the instant messaging system 100 of the present invention, as shown in FIG. 3A, the user manually assigns the identity classification of the contactor 200 by using the identity classifying unit (not shown) in the instant messaging system 100 according to the personal interest or background of the contactor 200. Another method for classifying the identity classification of the contactor 200 can be accomplished more intellectually through the instant messaging system 100, that is, by determining the identity classification of each contactor 200 in the instant messaging system 100 used by the user according to the identity classification setting of other contactor 200 in the respective instant messaging system 100. In this method, a service of updating the identity classification of the contactor 200 actively is provided by using the instant messaging system server 50. Since the instant messaging system server 50 can keep the communication among the instant messaging systems all the time, when the contactor 200 alters the identity classification setting in his/her own instant messaging system 100 (e.g., alters from athletics to fashion), the user can alter and classify the corresponding identity classification (e.g., alters from athletics to fashion) of the contactor 200 actively in the instant messaging system 100 through a updating service of the instant messaging system server 50, without requiring a manual setting.

Then, when the user is unwilling to reply to the text message 212 sent by the contactor 200 in person, the instant messaging system 100 of the present invention can be set to an automatic reply status, and a reply mode of the automatic reply is set by presetting the reply mode setting unit 141. Meanwhile, in order to help the user to understand the set reply mode, as shown in FIG. 3B, the reply mode setting unit 141 has an image database 142 (see FIG. 1), an image 143 in the image database 142 is displayed on the screen, and after the user sets the reply mode, the instant messaging system 100 of the present invention is in an automatic reply state. As shown in FIG. 3C, after the message 210 of the contactor 200, e.g., “Hello!”, is received (Step 1000), since the message 210 includes the identity classification message 211 and the text message 212, the recognition unit 120 can identify the identity classification of the contactor 200 through the identity classification message 211 together with the classification of the contactor 200, for example, if the identity classification message of the contactor 200 is sports, the recognition unit 120 identifies the identity classification of the contactor 200 to be sports classification (Step 1100). The message meaning identification unit 130 identifies the meaning of the text message 212 through the text message 212 (Step 1200). Then, as shown in FIG. 3D, texts are selected from a text database 150 through the previously set reply mode according to the identity classification message 211 (sports classification) and the meaning of the text message 212, and the texts are constituted into a reply message 220 by the message constituting unit 140, e.g., “Hi! Have you watched the football game last night?” (Step 1300). Finally, the reply message 220 (Hi! Have you watched the football game last night?) is sent to the contactor 200 through a message sending unit 160 (Step 1400). Therefore, the object of replacing the user to reply to the message is achieved.

In view of the above, the present invention relates to an automatic-reply instant messaging system and a method thereof, which reply to a message according to the identity classification of the contactor and the meaning of the message, when the user is unwilling to or incapable of replying to the message, the instant messaging system can act as the user's agent to reply with an appropriate message.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An automatic-reply instant messaging method applicable to a computer executable platform, at least comprising the following steps of:
receiving a message of at least one contactor;
recognizing an identity classification of the contactor through a recognition unit;
identifying a meaning of the message through a message meaning identification unit;
selecting texts from a text database according to the identity classification and the meaning, and constituting the texts into a reply message through a message constituting unit; and
sending the reply message to the contactor through a message sending unit.

2. The automatic-reply instant messaging method as claimed in claim 1, wherein the message comprises a text message and an identity classification message.

3. The automatic-reply instant messaging method as claimed in claim 1, further comprising classifying the identity classification of the contactor through an identity classifying unit.

4. The automatic-reply instant messaging method as claimed in claim 1, further comprising actively updating and classifying the identity classification of the contactor through an instant messaging system server.

5. The automatic-reply instant messaging method as claimed in claim 1, wherein the message constituting unit has a reply mode setting unit for constituting the reply message according the preset reply mode.

6. The automatic-reply instant messaging method as claimed in claim 5, wherein the reply mode setting unit has an image database and the reply mode is set according to the images in the image database.

7. An automatic-reply instant messaging system applicable to a computer executable platform, at least comprising:
a receiving unit, for receiving a message of at least one contactor;
a recognition unit, for recognizing a identity classification of the contactor;
a message meaning identification unit, for identifying a meaning of the message;
a text database;
a message constituting unit, for selecting texts from the text database according to the identity classification and the meaning of the message and constituting the texts into a reply message; and
a message sending unit, for sending the reply message to the contactor.

8. The automatic-reply instant messaging system as claimed in claim 7, further comprising an identity classifying unit for classifying the identity classification of the contactor.

9. The automatic-reply instant messaging system as claimed in claim 7, further comprising an instant messaging system server for actively updating and classifying the identity classification of the contactor.

10. The automatic-reply instant messaging system as claimed in claim 7, wherein the message constituting unit has a reply mode setting unit for constituting the reply message according the preset reply mode.

11. The automatic-reply instant messaging method as claimed in claim 10, wherein the reply mode setting unit has an image database and the reply mode is set according to the images in the image database.

12. The automatic-reply instant messaging system as claimed in claim 10, wherein the message comprises a text message and an identity classification message.
